(19) United States
(12) Patent Application Publication
(10) Pub. No.: US 2012/0246236 A1
(43) Pub. Date: Sep. 27, 2012

(54) NETWORK SYSTEM, COMMUNICATION METHOD, COMMUNICATION TERMINAL, AND COMMUNICATIONS SERVER

(76) Inventors: Toshio Akabane, Osaka-shi (JP); Masaki Yamamoto, Osaka-shi (JP); Tatsuya Sakai, Osaka-shi (JP)

(21) Appl. No.: 13/514,534

(22) PCT Filed: Dec. 6, 2010
(86) PCT No.: PCT/JP2010/071815

§ 371 Date: Jun. 7, 2012

(30) Foreign Application Priority Data
Dec. 8, 2009 (JP) 2009-278283

(51) Int. Cl. G06F 15/16

(52) U.S. Cl. 709/204

(57) ABSTRACT

A network system includes a server and a plurality of terminals. The server stores contents and a status showing the state of the terminal for each room. The server stores the status received from the terminal and associated with the room, and transmits the contents and the status associated with the designated room to the terminal. Each of the plurality of terminals transmits the status to the server, transmits designation of the room input through an input device to the server, and causes a display to show the contents and the status received from the server.

### TECHNICAL FIELD

The present invention relates to a network system technique by which a terminal acquires contents from a server, and particularly to a network system technique by which each of a plurality of terminals receives contents of a room associated with a user of each of the plurality of terminals

### BACKGROUND ART

The service providing a chat room and a bulletin board to the user of the terminal is known. In this service, a plurality of users (terminals) issue requests to a service provider (server) to provide a virtual place (chat room) for exchanging messages among the plurality of users. In response to the requests, the service provider provides the plurality of users with a chat room, a bulletin board and the like allocated for each user.

For example, Japanese Patent Laying-Open No. 2004-199134 (PTL 1) discloses a chat system. According to Japanese Patent Laying-Open No. 2004-199134 (PTL 1), when a new chat room is established, the chat server necessitates input of an e-mail address of the user urged to enter the chat room, or necessitates selection of an e-mail address of the user urged to enter the chat room from the user information registered in advance, and, after establishment of the chat room, transmits an e-mail message notifying establishment of the chat room to this e-mail address. Even if the personal computer of the owner of the chat room and the personal computer of another user are not connected to each other such that the chat room can be shared, this another user can be notified of establishment of the chat room, to positively urge this user to enter the chat room, thereby allowing reduction in the wasteful waiting time period.

Furthermore, Japanese Patent Laying-Open No. 2006-107306 (PTL 2) discloses a server rental system. Japanese Patent Laying-Open No. 2006-107306 (PTL 2) discloses a server rental system for allowing a user terminal wishing to hold and join an event to use the chat room as a chat room obtained by dividing the server managed by a server manager. The server rental system is characterized by including room owner accepting means for accepting a request from the user who wishes to hold an event and renting a chat room within the server to the user; and guest accepting means for permitting the user wishing to join the event to enter the chat room as a guest.

Furthermore, Japanese Patent Laying-Open No. 2002-108792 (PTL 3) discloses a chatting method. According to Japanese Patent Laying-Open No. 2002-108792 (PTL 3), a user authentication unit examines whether or not the user has an access right that allows the user to refer to the stored statement contents. A statement contents storing region stores the contents stated in the chat room in real time. A search unit searches the statement contents storing region for the statement matching the conditions from a client. Notification means notifies all members in the chat room that the past statement contents have been referred to.

### Citation List

### Patent Literature

### PTL 1: Japanese Patent Laying-Open No. 2004-199134

### PTL 2: Japanese Patent Laying-Open No. 2006-107306

### PTL 3: Japanese Patent Laying-Open No. 2002-108792

### SUMMARY OF INVENTION

### Technical Problem

In the conventional chat system, however, unless the user employs the communication means such as a telephone and e-mail, the user could not grasp whether or not the other person who chats with the user also accesses the room being accessed by the user, or whether or not the other person who chats with the user also views the contents being viewed by the user. In other words, the user could not grasp the state of the other person who chats with the user.

The present invention has been made to solve the above-described problems. An object of the present invention is to provide a network system that allows the user to grasp the state of the person who communicates with the user without having to utilize other communication means.

### Solution to Problem

According to an aspect of the present invention, a network system including a plurality of terminals and a server is provided. The server includes a server communication device for communicating with the plurality of terminals; a memory for storing, for each room corresponding to a user of each of the plurality of terminals, contents and a status showing a state of the terminal; and a server processor having first server control storing the status transmitted from the terminal in the memory, the status being associated with the room corresponding to the user of the terminal, and second server control referring to the memory in accordance with designation of the room transmitted from the terminal, to transmit the contents and the status associated with the designated room to the terminal. Each of the plurality of terminals includes a display, an input device, a terminal communication device for communicating with the server, and a terminal processor having first terminal control transmitting the state of a user's own terminal as the status to the server, and second terminal control transmitting the designation of the room input through the input device to the server, to cause the display to show the contents and the status corresponding to the designated room transmitted from the server.

Preferably, the status showing the state of the terminal shows whether or not the terminal displays the contents of the room corresponding to the user of the terminal.

Preferably, the server processor refers to the memory based on a first request from the terminal to transmit a list showing the status corresponding to each of a plurality of the rooms through the server communication device. The terminal processor causes the display to show the list received from the server, and accepts an instruction for selecting the room as designation of the room from the list through the input device.

Preferably, in response to a second request from the terminal, the server processor inhibits another terminal of the plurality of terminals from accessing the room corresponding to the terminal.

According to another aspect of the present invention, a communication method in a network system including a plurality of terminals and a server is provided. The server includes a memory storing, for each room corresponding to a user of each of the plurality of terminals, contents and a status showing a state of the terminal. The communication method includes the steps of: a first terminal of the plurality of terminals transmitting a status of the first terminal to the server; the server storing the status of the first terminal in the memory; a second terminal of the plurality of terminals transmitting designation of the room corresponding to the user of the first terminal to the server; the server transmitting the contents and the status corresponding to the designated room to the second terminal; and the second terminal causing a display to show the contents and the status.

According to another aspect of the present invention, a communication terminal for communicating with a server storing contents and a status for each room is provided.

The communication terminal includes a display; an input device; a terminal communication device for communicating with the server; and a terminal processor having first terminal control transmitting a state of a user's own terminal as the status to the server, and second terminal control transmitting designation of the room input through the input device to the server, to cause the display to show the contents and the status corresponding to the designated room transmitted from the server.

According to another aspect of the present invention, a communications server is provided that includes a server communication device for communicating with a plurality of terminals; a memory storing, for each room corresponding to a user of each of the plurality of terminals, contents and a status showing a state of the terminal; and a server processor having first server control storing the status transmitted from the terminal in the memory, the status being associated with the room corresponding to the user of the terminal, and second server control referring to the memory in accordance with designation of the room transmitted from the terminal, to transmit the contents and the status associated with the designated room to the terminal.

### Advantageous Effects of Invention

As described above, the present invention allows the user to grasp the state of the other person who communicates with the user without having to utilize other communication means.

### BRIEF DESCRIPTION OF DRAWINGS

FIG. 1 is a schematic diagram of a network system according to the present embodiment.

FIG. 2 is an image diagram showing the relationship among rooms for each user established in a server according to the present embodiment.

FIG. 3 is an image diagram showing a list transmitted from the server.

FIG. 4 is an image diagram showing the external appearance of a communication terminal according to the present embodiment.

FIG. 5 is a block diagram showing the hardware configuration of the communication terminal according to the present embodiment.

FIG. 6 is a block diagram showing the hardware configuration of the server according to the present embodiment.

FIG. 7 is an image diagram showing a room management database stored in a memory of the communication terminal according to the present embodiment.

FIG. 8 is a flowchart illustrating the process procedure of the login process in the communication terminal according to the present embodiment.

FIG. 9 is a flowchart illustrating the process procedure of the process for entering the user's own room in the communication terminal according to the present embodiment.

FIG. 10 is an image diagram showing a touch panel displaying the user's own room immediately after logging-in.

FIG. 11 is an image diagram showing the touch panel displaying the user's own room after the drawing operation performed by the user.

FIG. 12 is an image diagram showing the touch panel displaying the user's own room after the drawing operation performed by another user.

FIG. 13 is an image diagram showing the touch panel at the time when the status is switched.

FIG. 14 is a flowchart illustrating the process procedure of the list displaying process in the communication terminal according to the present embodiment.

FIG. 15 is a flowchart illustrating the process procedure of the process for entering the room of another user in the communication terminal according to the present embodiment.

FIG. 16 is an image diagram showing the touch panel displaying the room of another user.

FIG. 17 is the first flowchart illustrating the process procedure in the server according to the present embodiment.

FIG. 18 is the second flowchart illustrating the process procedure in the server according to the present embodiment.

FIG. 19 is the third flowchart illustrating the process procedure in the server according to the present embodiment.

FIG. 20 is the fourth flowchart illustrating the process procedure in the server according to the present embodiment.

FIG. 21 is an image diagram showing the list at initialization.

### DESCRIPTION OF EMBODIMENTS

The embodiments of the present invention will be hereinafter described with reference to the accompanying drawings. In the following description, the same components are designated by the same reference characters. Names and functions thereof are also the same. Accordingly, the detailed description thereof will not be repeated.

<Entire Configuration of Network System 1>

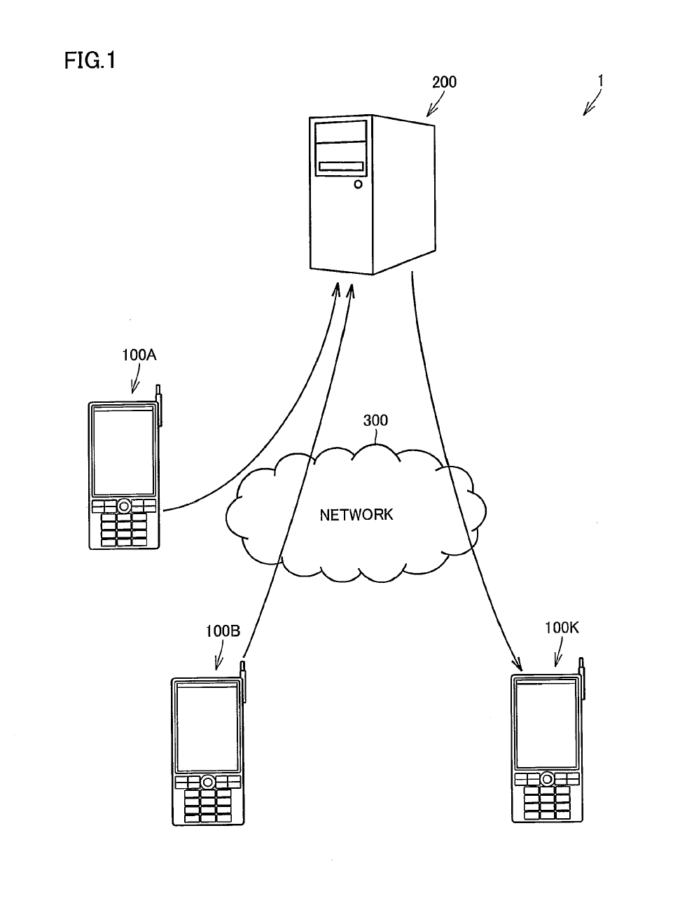

A network system 1 according to the present embodiment will be first described. FIG. 1 is a schematic diagram of network system 1 according to the present embodiment.

Referring to FIG. 1, network system 1 according to the present embodiment includes a plurality of communication terminals 100A, 100B and 100K, a server 200, and a network 300. Communication terminals 100A, 100B and 100K each may be other information communication equipment such as a mobile phone, a personal computer (which will be hereinafter referred to as a PC), a PND (Personal Navigation Device), and a PDA (Personal Data Assistance). Network 300 may consist of dedicated lines such as a LAN (Local Area Network) and a WAN (Wide Area Network), or public lines such as the Internet and a virtual private network, and furthermore, may be partially or entirely a wireless communications line such as a wireless LAN.

Each of communication terminals 100A, 100B, 100K and server 200 can be connected to network 300. Each of communication terminals 100A, 100B, 100K and server 200 may be further connectable to network 300 through a carrier network, a LAN (Local Area Network) and a WAN (Wide Area Network) which are not shown.

More specifically, communication terminals 100A, 100B, 100K and server 200 are allocated with identification information (for example, an e-mail address, an IP (Internet Protocol) address, and the like) for identifying themselves. In the present embodiment, when communication terminals 100A, 100B and 100K access network 300, the IP addresses are allocated to communication terminals 100A, 100B and 100K by the server or the like that is not shown. Since the details of the IP address allocating process are known, description thereof will not be repeated.

Communication terminals 100A, 100B, 100K and server 200 each have a recording medium provided therein, which stores the information for identifying other communication terminals. This allows communication terminals 100A, 100B, 100K, and server 200 to perform transmission and reception of the data to and from other devices through network 300 and the like based on the information for identifying these other devices.

Server 200 establishes a room for each of the users of communication terminals 100A, 100B and 100K. More specifically, server 200 stores the contents (page information) such as text and images for each room associated with the user. By transmitting a viewing request to server 200, communication terminals 100A, 100B and 100K each can view the contents of each room. By transmitting a drawing request to server 200, communication terminals 100A, 100B and 100K each can update the contents of each room.

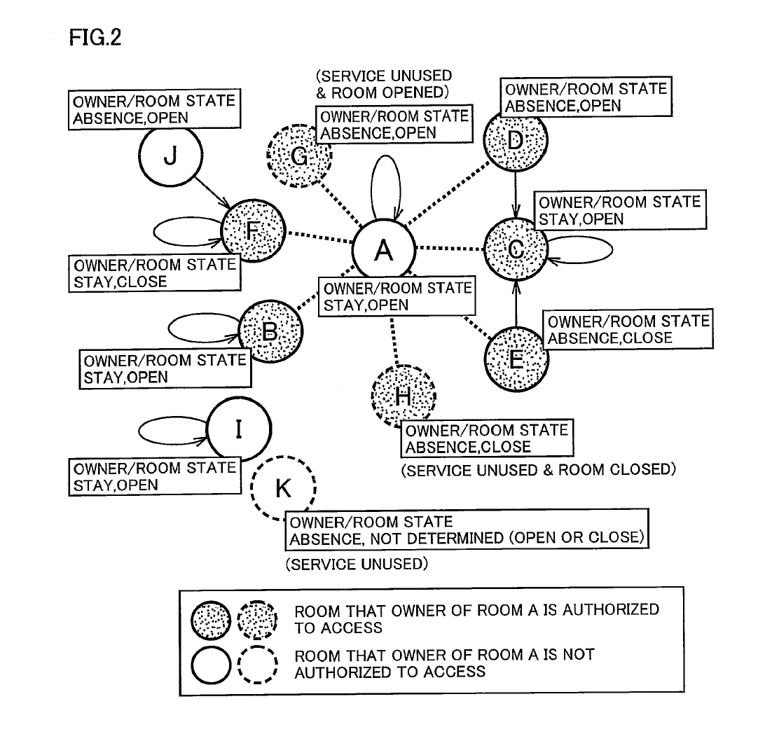

FIG. 2 is an image diagram showing the relationship among the rooms for each user established in server 200 according to the present embodiment. Referring to FIG. 2, rooms A, B, C, D, E, F, G, H, I, J, and K are established in server 200 according to the present embodiment. The users of communication terminals 100A, 100B and 100K are defined as owners of their respective rooms.

In association with rooms A, B, C, D, E, F, G, H, I, J, and K, respectively, server 200 stores the users (communication terminals) accessible to any of these rooms. For example, the user of communication terminal 100A that is an owner of room A can access rooms B, C, D, E, F, G, and H.

In association with rooms A, B, C, D, E, F, G, H, I, J, and K, respectively, server 200 stores the information (status) showing whether or not the users (communication terminals) that are the owners of these rooms are viewing the contents of their own room (during STAY). For example, the users who are the owners of rooms A, B, C, F, and I are viewing the contents of their own rooms. The users may return to their own rooms after viewing the contents of another room or may view only the contents of their own rooms from the beginning. On the other hand, the users who are the owners of rooms D, E, G, H, J, and K are viewing the contents of another room or do not use the service.

In association with rooms A, B, C, D, E, F, G, H, I, J, and K, respectively, server 200 stores the information showing whether or not other users (communication terminals) can enter any of these rooms, that is, the information showing whether or not other users (communication terminals) can acquire the contents of any of these rooms. For example, in the timing shown in FIG. 2, the contents of rooms A, B, C, D, G, I, and J can be viewed by other users. The contents of rooms E, F, H and K cannot be viewed by other users.

Then, in network system 1 according to the present embodiment, each of the communication terminals acquires, from server 200, the list of rooms among rooms A, B, C, D, E, F, G, H, I, J, and K that the user of the communication terminal is authorized to access. The list includes the status associated for each room. Server 200 transmits, to each of the communication terminals, the list of rooms among rooms A, B, C, D, E, F, G, H, I, J, and K that the communication terminal can currently enter. In other words, server 200 transmits, to the relevant communication terminal, the list of rooms among rooms A, B, C, D, E, F, G, H, I, J, and K that the user of the communication terminal is authorized to access and into which the user of the communication terminal can enter.

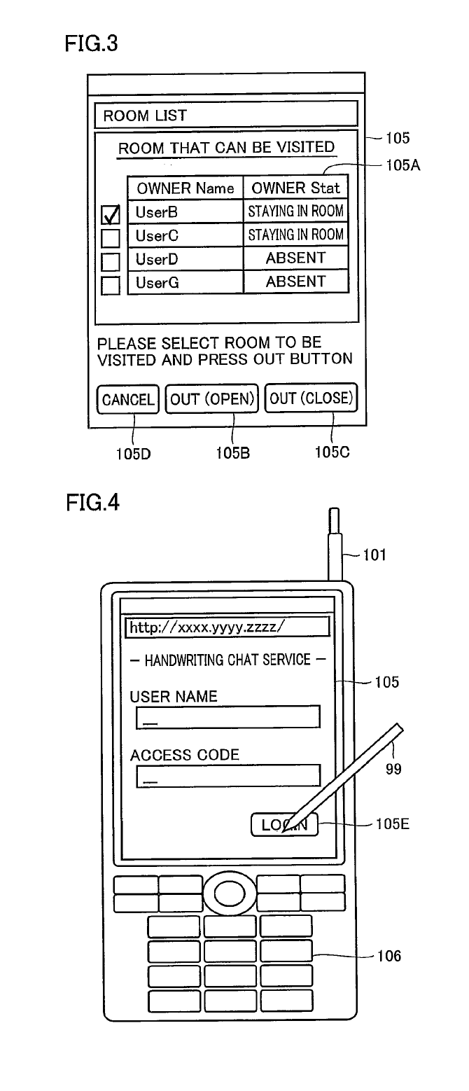

FIG. 3 is an image diagram showing a list 105A transmitted from server 200. As shown in FIG. 3, for example, communication terminal 100A displays list 105A transmitted from the server on its touch panel 105. By selecting the room that the user wishes to enter from list 105A, the user can view the contents of this room.

Then, in network system 1 according to the present embodiment, when the user selects a room, the user can grasp whether or not another user who is an owner of this selected room is viewing the contents of this room. In other words, after grasping whether or not other users who are the owners of their respective rooms are viewing their own rooms, the user can view the image and text in each of these rooms or can write the image and text into each of these rooms.

The configuration of network system 1 for implementing such a function will be hereinafter described in detail.

<Hardware Configuration of Communication Terminal 100>

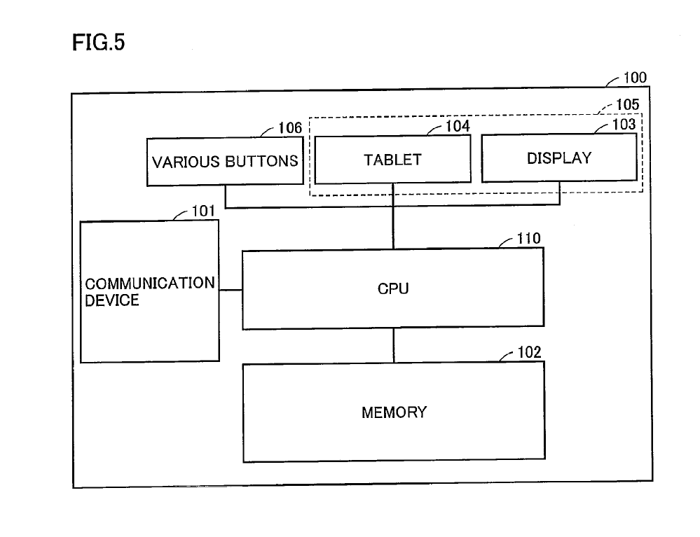

The hardware configuration of a communication terminal 100 according to the present embodiment will then be described. Communication terminals 100A, 100B and 100K will be also hereinafter collectively referred to as communication terminal 100. FIG. 4 is an image diagram showing the external appearance of communication terminal 100 according to the present embodiment. FIG. 5 is a block diagram showing the hardware configuration of communication terminal 100 according to the present embodiment.

As shown in FIGS. 4 and 5, communication terminal 100 according to the present embodiment includes a communication device 101 transmitting and receiving data to and from an external communication terminal through a network, a memory 102 storing a program and various pieces of data, a display 103 displaying contents, a tablet 104 accepting an instruction, a button 106 accepting inputs of various pieces of information, and a CPU (Central Processing Unit) 110 for controlling each unit of communication terminal 100.

Communication device 101 converts the output data from CPU 110 into a communication signal and issues the communication signal through an antenna. Communication device 101 converts the received communication signal into input data through the antenna and inputs the input data into CPU 110.

Display 103 according to the present embodiment is composed of a liquid crystal panel or a CRT (Cathode Ray Tube). Also, in the communication terminal according to the present embodiment, tablet 104 is disposed below (on the underside of) display 103. Accordingly, the user can use, for example, a stylus pen, a finger and the like to input the graphic information and the like into CPU 110 in handwriting through tablet 104.

Display 103 and tablet 104 according to the present embodiment constitute the so-called touch panel 105. The user uses a stylus pen 99 and the like to input an instruction, a handwritten image and the like into touch panel 105.

Button 106 accepts information from the user through a key input operation and the like. For example, button 106 including a numerical key, a decision key and the like accepts input of characters, instructions for selection and the like.

CPU 110 controls each unit of communication terminal 100. CPU 110 may be any one of a microprocessor, an FPGA (Field Programmable Gate Array), an ASIC (Application Specific Integrated Circuit), a DSP (Digital Signal Processor), and any other circuits having computing functions.

CPU 110 reads a control program from memory 102 and executes this control program. Then, CPU 110 receives various instructions from the user through button 106. CPU 110 performs transmission and reception of data to and from server 200 or an external communication terminal through communication device 101 or network 300.

For example, CPU 110 transmits the handwritten image accepted through tablet 104 and the text accepted through button 106 as contents to server 200 through communication device 101. CPU 110 receives contents and lists from server 200 through communication device 101. CPU 110 stores the contents and the lists in memory 102. CPU 110 causes display 103 to show the contents and the lists.

Memory 102 is implemented, for example, by a RAM (Random Access Memory), an SRAM (Static Random Access Memory), a DRAM (Dynamic Random Access Memory), an SDRAM (Synchronous DRAM), a DDR-SDRAM (Double Data Rate SDRAM), a RDRAM (Rambus Dynamic Random Access Memory (registered trademark)), a Direct-RDRAM (Direct Rambus Dynamic Random Access Memory (registered trademark)), a flash memory, a ROM (Read Only Memory), a mask ROM, a

PROM (Programmable Read Only Memory), an EPROM (Erasable Programmable ROM), an EEPROM (Electrically Erasable PROM), a FeRAM (Ferroelectric Random Access Memory), a hard disk, other circuits capable of recording and holding data, and the like.

<Hardware Configuration of Server 200>

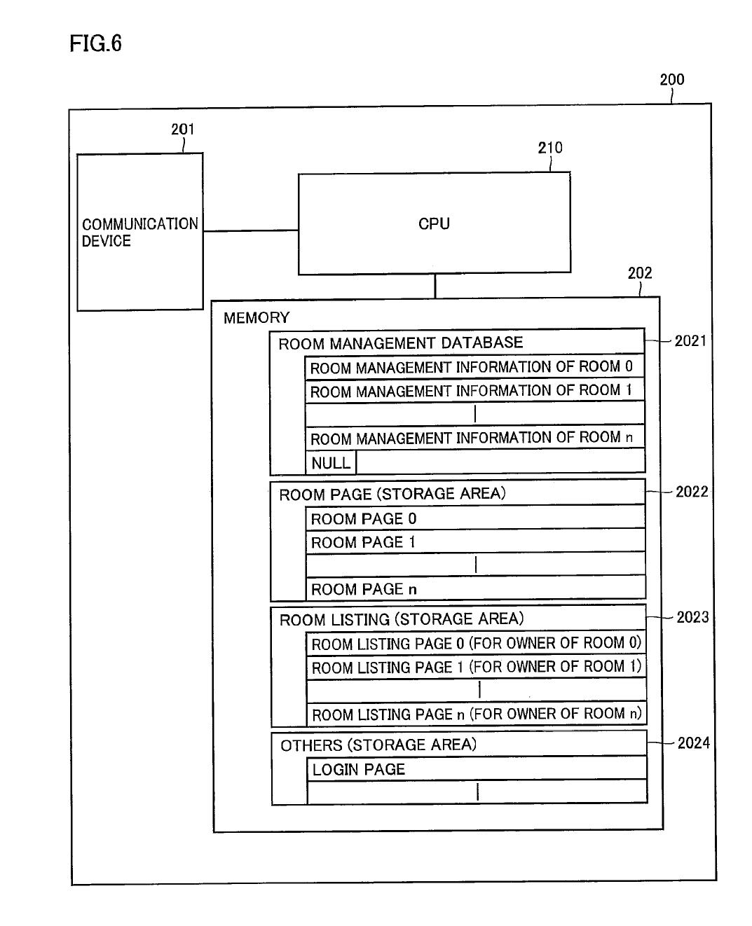

Then, the hardware configuration of server 200 according to the present embodiment will be described. FIG. 6 is a block diagram showing the hardware configuration of server 200 according to the present embodiment.

Referring to FIG. 6, server 200 according to the present embodiment includes a communication device 201 transmitting and receiving data to and from external communication terminal 100 through network 300, a memory 202 storing a program and various pieces of data, and a CPU (Central Processing Unit) 210 for controlling each unit of server 200.

Communication device 201 converts the output data from CPU 210 into a communication signal, and issues the communication signal through an antenna. Communication device 201 converts the communication signal received through the antenna into input data, and inputs the input data into CPU 210.

CPU 210 controls each unit of server 200. CPU 210 may be any of a microprocessor, an FPGA, an ASIC, a DSP, and other circuits having computing functions.

CPU 210 reads a control program from memory 202 and executes this control program. Then, CPU 210 performs transmission and reception of data to and from external communication terminal 100 through communication device 201, network 300 and the like.

For example, CPU 210 accepts designation of the room from communication terminal 100 through communication device 201. CPU 210 receives contents, a status, a list request (the first request), and an entrance rejection request (the second request) from communication terminal 100 through communication device 201. CPU 210 stores the contents and the status in memory 202.

CPU 210 transmits the contents and the status of the designated room to communication terminal 100 through communication device 201. In response to the list request, CPU 210 transmits the list to communication terminal 100 through communication device 201. In response to the entrance rejection request, CPU 210 changes the entrance permitted state of memory 202.

Memory 202 is implemented, for example, by a RAM, an SRAM, a DRAM, an SDRAM, a DDR-SDRAM, a RDRAM, a Direct-RDRAM, a flash memory, a ROM, a mask ROM, a PROM, an EPROM, an EEPROM, an FeRAM, a hard disk, other circuits capable of recording and holding data, and the like.

In the following description, the data stored in memory 202 of server 200 according to the present embodiment will be explained. Referring to FIG. 6, memory 202 stores the room management information about rooms A, B, C, D, E, F, G, H, I, J, and K as a room management database 2021. Memory 202 stores the contents of rooms A, B, C, D, E, F, G, H, I, J, and K (page viewed by other users) as a room page 2022. Memory 202 stores the viewing page for each owner of rooms A, B, C, D, E, F, G, H, I, J, and K as a room listing 2023. Memory 202 stores a login page 2024.

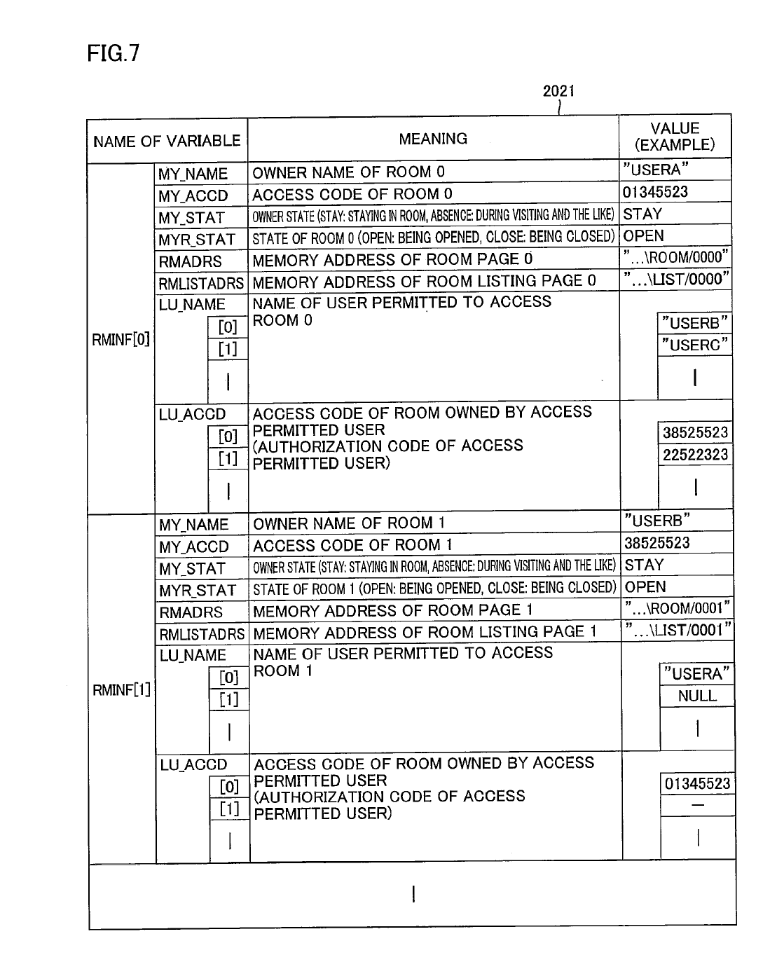

In the following description, room management database 2021 stored in memory 102 of communication terminal 100 according to the present embodiment will be explained. FIG. 7 is an image diagram showing room management database 2021 stored in memory 102 of communication terminal 100 according to the present embodiment.

Referring to FIG. 7, room management database 2021 stores the room owner's name (MY_NAME) for each room. Room management database 2021 stores the room's access code (MY_ACCD) for each room.

Room management database 2021 stores the state of the room's owner (MY_STAT) for each room in accordance with the status received from the room's owner. For example, while communication terminal 100 of the room's owner is viewing the contents of the owner's own room, the state of the room's owner (MY_STAT) is represented as staying in the room (STAY). On the other hand, while communication terminal 100 of the room's owner is not viewing the contents of the owner's own room, the state of the room's owner (MY_STAT) is represented as during visiting (ABSENCE).

Room management database 2021 stores a room state (MYR_STAT) for each room in response to the request received from the room's owner. For example, when a new user can enter the room, the room state (MYR_STAT) is represented as being opened (OPEN). On the other hand, when a new user cannot enter the room, the room state (MYR_STAT) is represented as being closed (CLOSE).

Room management database 2021 stores a memory address of the room page, that is, the storage position of the contents (RMADRS), for each room. Room management database 2021 stores the memory address of the room listing page, that is, the storage position of the listing page of another page that can be viewed by the owner (RMLISTADRS), for each room.

Room management database 2021 stores, for each room, a user name (LU_NAME) permitted to access the room. Room management database 2021 stores, for each room, an access code (LU_ACCD) of the room owned by the user who is permitted to access the room.

<Login Process>

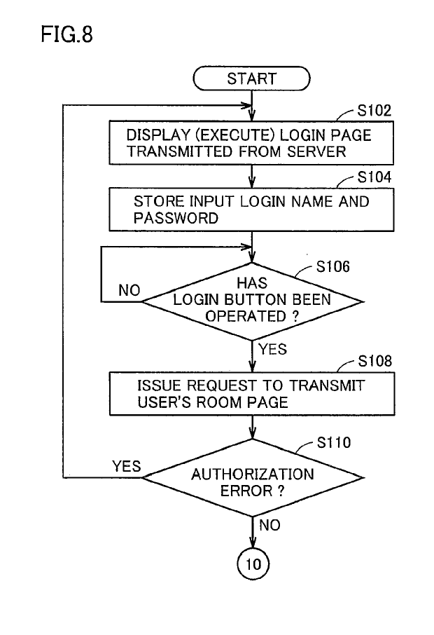

Then, an explanation will be given with regard to the process procedure of the login process at the start of use of the service in communication terminal 100 according to the present embodiment. FIG. 8 is a flowchart illustrating the process procedure of the login process in communication terminal 100 according to the present embodiment.

Referring to FIG. 8, CPU 110 issues a request for a login page to server 200 through communication device 101, thereby receiving a login page from the server (step S102). CPU 110 causes display 103 to show the received login page. As shown in FIG. 4, CPU 110 causes display 103 to show the area into which a user name is input, an area into which an access code is input and a login button 105E.

CPU 110 stores the user name and the access code in memory 102 which are input through touch panel 105 or button 106 (step S104). CPU 110 determines whether or not the user has operated the login button through touch panel 105 (step S106). If the user has not operated the login button (NO in step S106), CPU 110 repeats the process from step S106.

If the user has operated the login button (YES in step S106), CPU 110 issues a request to server 200 through communication device 101 to transmit the user's login page (step S108). More specifically, CPU 110 transmits the command name (ACCESS_MYRM), the input user name (Per1) and the input access code (Per2) to server 200 through communication device 101.

CPU 110 determines whether or not an error message about login authentication has been received from the server through communication device 101 (step S110). When having received the error message about login authentication from server 200 (YES in step S110), CPU 110 repeats the process from step S102. When having not received the error message about login authentication from server 200 (NO in step S110), CPU 110 performs the process from step S202.

<Process for Entering User's Own Room>

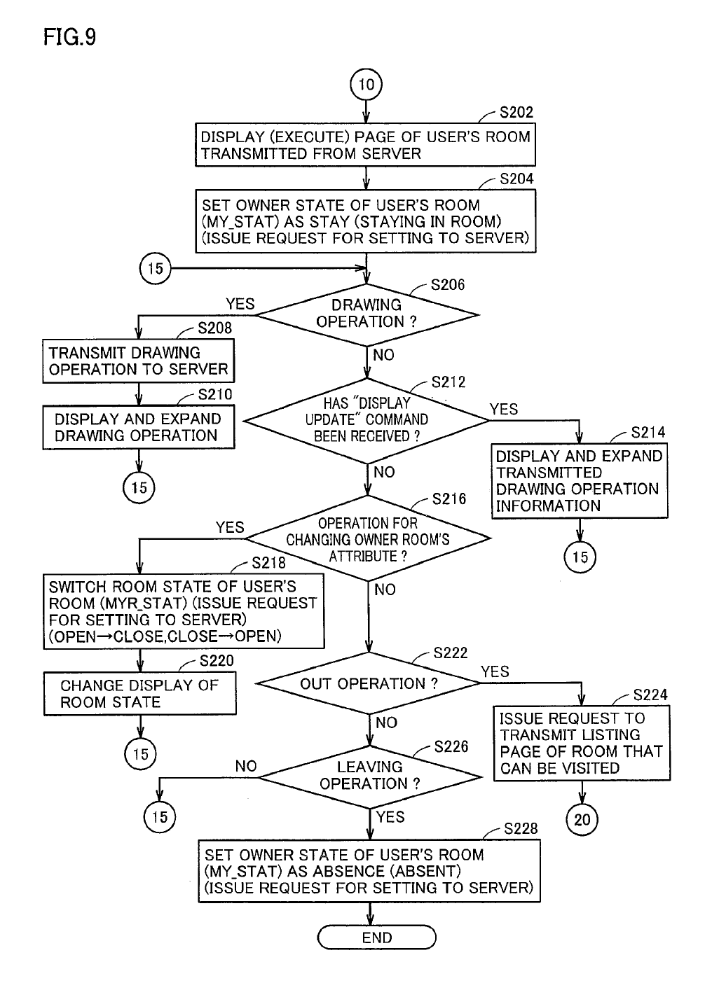

Then, an explanation will be given with regard to the process procedure of the process for entering the user's own room in communication terminal 100 according to the present embodiment. FIG. 9 is a flowchart illustrating the process procedure of the process for entering the user's own room in communication terminal 100 according to the present embodiment.

Referring to FIG. 9, CPU 110 receives the page (contents) of the user's own room from server 200 through communication device 101, and causes display 103 to show this page (step S202). The screen for displaying the user's own room will then be described.

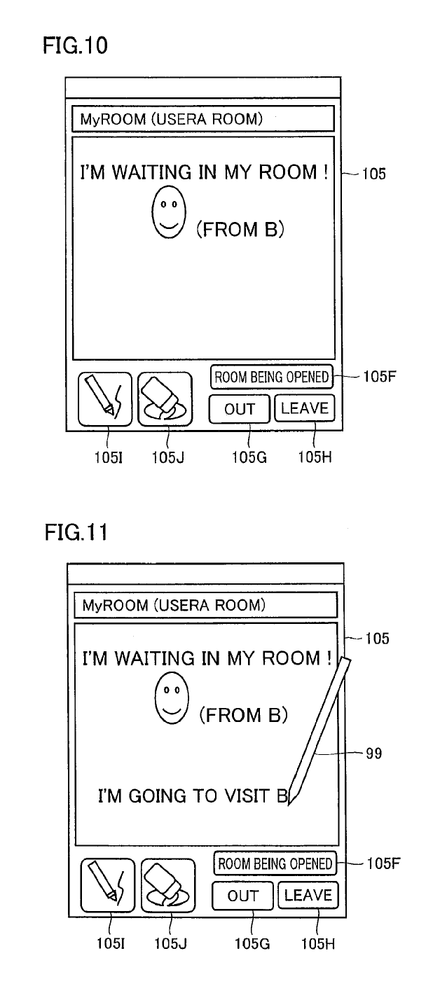

FIG. 10 is an image diagram showing touch panel 105 displaying the user's own room immediately after logging-in. Referring to FIG. 10, when displaying the user's own room, CPU 110 causes display 103 to show the contents already drawn by the user and the contents already drawn by other users. Together with the contents, CPU 110 causes display 103 to show a switching button 105F for switching access to the room between the permitted state and the inhibited state, an out button 105G for viewing the rooms of other users, a leave button 105H for logging out of the service, a drawing button 105I for providing input of an image, and a deletion button 105J for deleting an image.

Referring back to FIG. 9, CPU 110 issues a request to server 200 through communication device 101 to set the owner state of the user's room (MY_STAT) as STAY (staying in the room) (step S204). More specifically, CPU 110 transmits the command name (SET_OWNERST), the input user name (Per1), the input access code (Per2), and the information showing that the user is viewing the user's own room (Per3) to server 200 through communication device 101.

CPU 110 determines whether or not the drawing operation has been accepted from the user through touch panel 105 (step S206). If the drawing operation has been accepted (YES in step S206), CPU 110 transmits the input drawing operation to server 200 through communication device 101 (step S208). More specifically, CPU 110 transmits the command name (DRAW MYRM), the input user name (Per1), the input access code (Per2), and the information showing the drawing operation (Per3) to server 200 through communication device 101.

CPU 110 causes display 103 to show the drawing contents based on the input drawing operation (step S210). CPU 110 performs the process from step S206.

FIG. 11 is an image diagram showing touch panel 105 displaying the user's own room after the drawing operation performed by the user. Referring to FIG. 11, CPU 110 causes display 103 to show a new image and text based on the drawing operation accepted through touch panel 105.

Referring back to FIG. 9, if the drawing operation has not been accepted from the user (NO in step S206), CPU 110 determines whether or not a “display update” command has been received through communication device 101 (step S212). If the “display update” command has been received (YES in step S212), CPU 110 causes display 103 to show the drawing contents based on the received “display update” command (step S214). CPU 110 performs the process from step 5206. It is to be noted that this process is specifically to redisplay (reload) the page (contents) of the room that is transmitted from the server together with the “display update” command and includes the updated contents subjected to the drawing operation by another user.

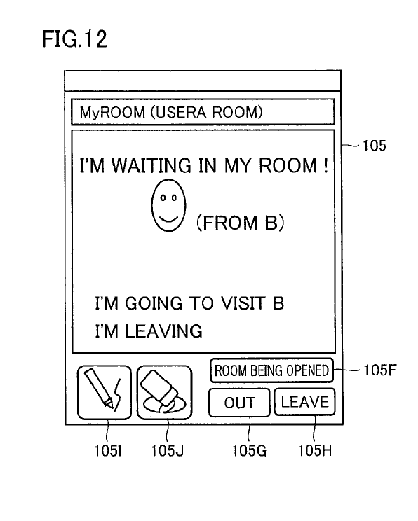

FIG. 12 is an image diagram showing touch panel 105 displaying the user's own room after the drawing operation performed by another user. Referring to FIG. 12,

CPU 110 causes display 103 to show a new image and text based on the received “display update” command.

Referring back to FIG. 9, if the “display update” command has not been received (NO in step S212), CPU 110 determines whether or not the operation for changing the owner room's attribute has been accepted through touch panel 105 from the user (step

S216). If the operation for changing the owner room's attribute has been accepted from the user (YES in step S216), CPU 110 issues a request to server 200 through communication device 101 to switch the room state of the user's own room (MYR_STAT) (step S218). More specifically, CPU 110 transmits the command name (SET MYRMST), the input user name (Per1), the input access code (Per2), and the information showing a new state (Per3) to server 200 through communication device 101.

CPU 110 changes the display of the room state through display 103 (step S220). CPU 110 performs the process from step S206.

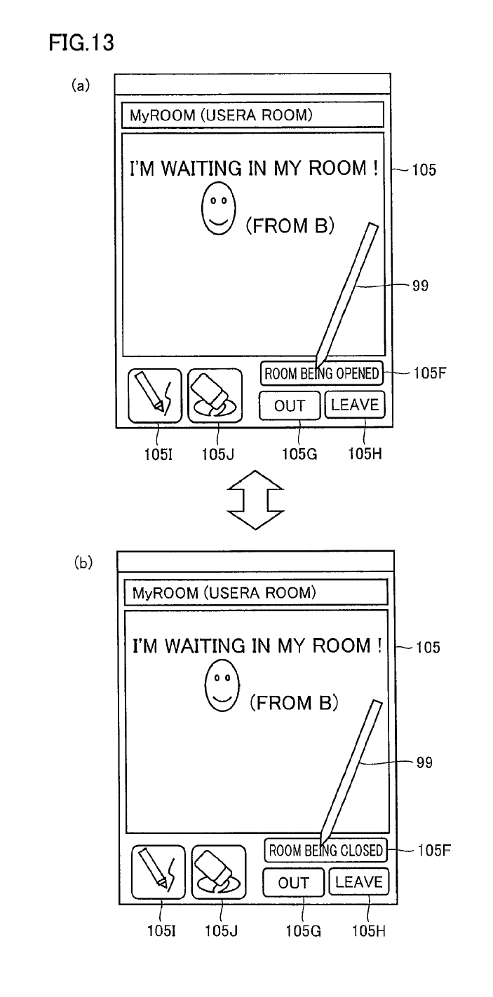

FIG. 13 is an image diagram showing touch panel 105 at the time when the status is changed. FIG. 13(A) is an image diagram showing touch panel 105 in the state where access to the room is permitted. FIG. 13(B) is an image diagram showing touch panel 105 in the state where access to the room is inhibited. As shown in FIG. 13, CPU 110 accepts the switching instruction from the user through switching button 105F on touch panel 105, thereby switching the access to the room by other terminals between the permitted state and the inhibited state.

Referring back to FIG. 9, if the operation for changing the owner room's attribute has not been accepted from the user (NO in step S216), CPU 110 determines whether or not the out operation has been accepted from the user through touch panel 105 (step S222). If the out operation has been accepted from the user (YES in step S222), CPU 110 issues a request to server 200 through communication device 101 to transmit the listing page of the room that can be visited by the user (step S224). More specifically, CPU 110 transmits the command name (GET RMLIST), the input user name (Per1) and the input access code (Per2) to server 200 through communication device 101. CPU 110 then performs the process from step S302.

If the out operation has not been accepted from the user (NO in step S222), CPU 110 determines whether or not a leaving operation has been accepted from the user through touch panel 105 (step S226). If the leaving operation has not been accepted from the user (NO in step S226), CPU 110 repeats the process from step S206.

If the leaving operation has been accepted from the user (YES in step 226), CPU 110 issues a request to server 200 through communication device 101 to set the owner state of the user's room (MY_STAT) as ABSENSCE (absent) (step S228). More specifically, CPU 110 transmits the command name (SET_OWNERST), the input user name (Per1), the input access code (Per2), and ABSENCE (Peri) to server 200 through communication device 101.

CPU 110 then ends the process for entering the user's room. In the present embodiment, CPU 110 causes display 103 to show the screen indicating completion of use of the service. For example, CPU 110 ends the application of the browser or changes the screen to a login screen.

<List Displaying Process>

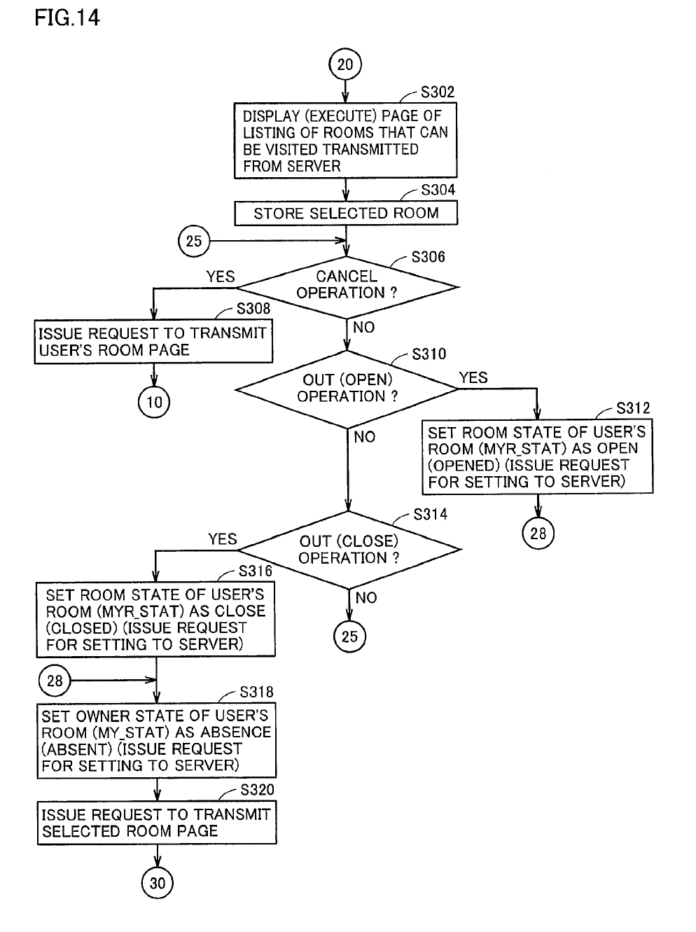

Then, the process procedure of the list displaying process in communication terminal 100 according to the present embodiment will be hereinafter described. FIG. 14 is a flowchart illustrating the process procedure of the list displaying process in communication terminal 100 according to the present embodiment.

Referring to FIG. 14, CPU 110 receives the page of the list from server 200 through communication device 101, and causes display 103 to show this page (step S302). The screen displaying the list will be hereinafter described. For example, as shown in FIG. 3, CPU 110 causes display 103 to show list 105A.

List 105A includes one or more rooms each associated with the user's viewing state. List 105A includes a check box associated with each of the rooms. The user can select a room by checking the check box through touch panel 105.

CPU 110 causes display 103 to show an out button 105B for viewing other rooms in the state where access to the user's room is permitted, an out button 105C for viewing other rooms in the state where access to the user's room is inhibited, and a cancel button 105D for canceling viewing of other rooms.

Referring back to FIG. 14, CPU 110 stores the room selected through touch panel 105 in memory 102 (step S304). CPU 110 determines whether or not the cancel operation has been accepted from the user through touch panel 105 (step S306). If the cancel operation has been accepted from the user (YES in step S306), CPU 110 issues a request to server 200 through communication device 101 to transmit the contents of the user's room (step S308). More specifically, CPU 110 transmits the command name (ACCESS MYRM), the input user name (Per1) and the input access code (Per2) to server 200 through communication device 101. CPU 110 then performs the process from step S202.

If the cancel operation has not been accepted from the user (NO in step S306), CPU 110 determines whether or not the out operation (OPEN) has been accepted from the user through touch panel 105 (step S310). In this case, it is determined whether or not the user has input an instruction to view the room of another user in the state where another user is permitted to access the user's room (OPEN).

If the out operation (OPEN) has been accepted from the user (YES in step S310), CPU 110 issues a request to server 200 through communication device 101 to set the room state of the user's room (MYR_STAT) as OPEN (opened) (step S312). More specifically, CPU 110 transmits the command name (SET_MYRMST), the input user name (Per1), the input access code (Per2), and OPEN (Per3) to server 200 through communication device 101. CPU 110 then performs the process from step S318.

If the out operation (OPEN) has not been accepted from the user (NO in step S310), CPU 110 determines whether or not the out operation (CLOSE) has been accepted from the user through touch panel 105 (step S314). In this case, it is determined whether or not the user has input an instruction to view the room of another user in the state where another user is inhibited from accessing the user's room (CLOSE).

If the out operation (CLOSE) has been accepted from the user (YES in step S314), CPU 110 issues a request to server 200 through communication device 101 to sets the room state of the user's room (MYR STAT) as CLOSE (closed) (step S316). More specifically, CPU 110 transmits the command name (SET_MYRNIST), the input user name (Per1), and the input access code (Per2), and CLOSE (Per3) to server 200 through communication device 101.

Furthermore, CPU 110 issues a request to server 200 through communication device 101 to set the owner state of the user's room (MY_STAT) as ABSENCE (absent) (step S318). More specifically, CPU 110 transmits the command name (SET_OWNERST), the input user name (Per1), the input access code (Per2), and ABSENCE (Per3) to server 200 through communication device 101.

CPU 110 issues a request to server 200 through communication device 101 to transmit the page of the selected room (step S320). CPU 110 then performs the process from step S402. More specifically, CPU 110 transmits the command name (ACCESS RM), the input user name (Per1), the input access code (Per2), the owner of the selected room (Per3), and the access code of the selected room (Per4) to server 200 through communication device 101.

If the out operation (CLOSE) has not been accepted from the user (NO in step S314), CPU 110 repeats the process from step S306.

<Process for Entering Room of Another User>

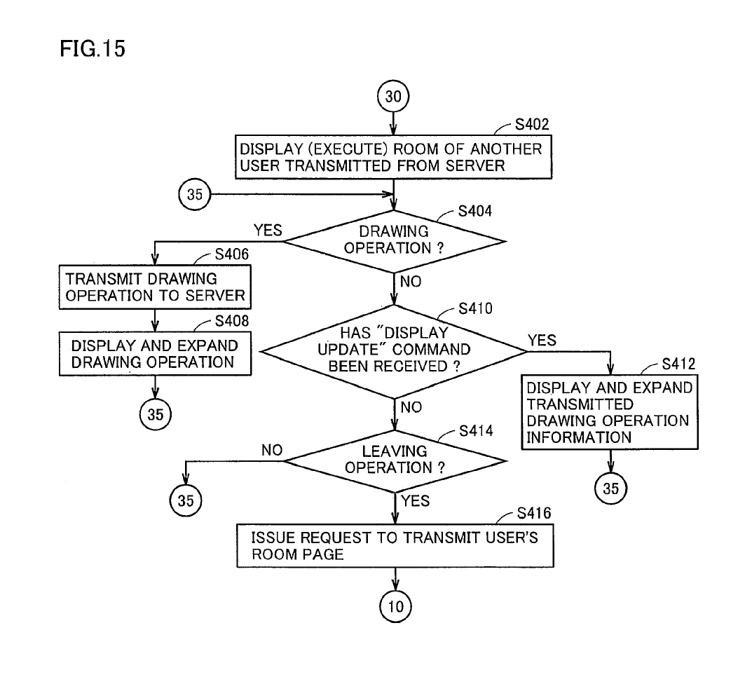

Then, an explanation will be given with regard to the process procedure of the process for entering the room of another user in communication terminal 100 according to the present embodiment. FIG. 15 is a flowchart illustrating the process procedure of the process for entering the room of another user in communication terminal 100 according to the present embodiment.

Referring to FIG. 15, CPU 110 receives the page of the room of another user from server 200 through communication device 101, and causes display 103 to show this room (step S402). The screen for displaying the room of another user will then be described.

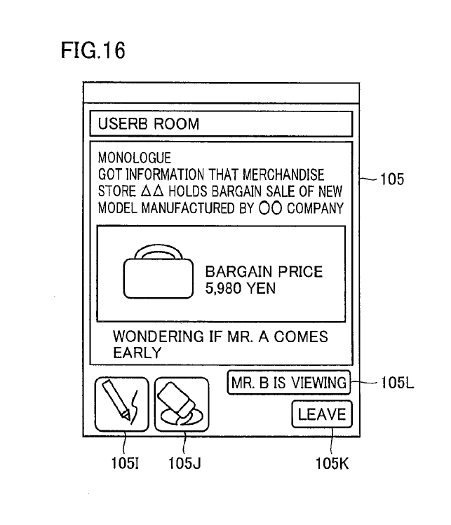

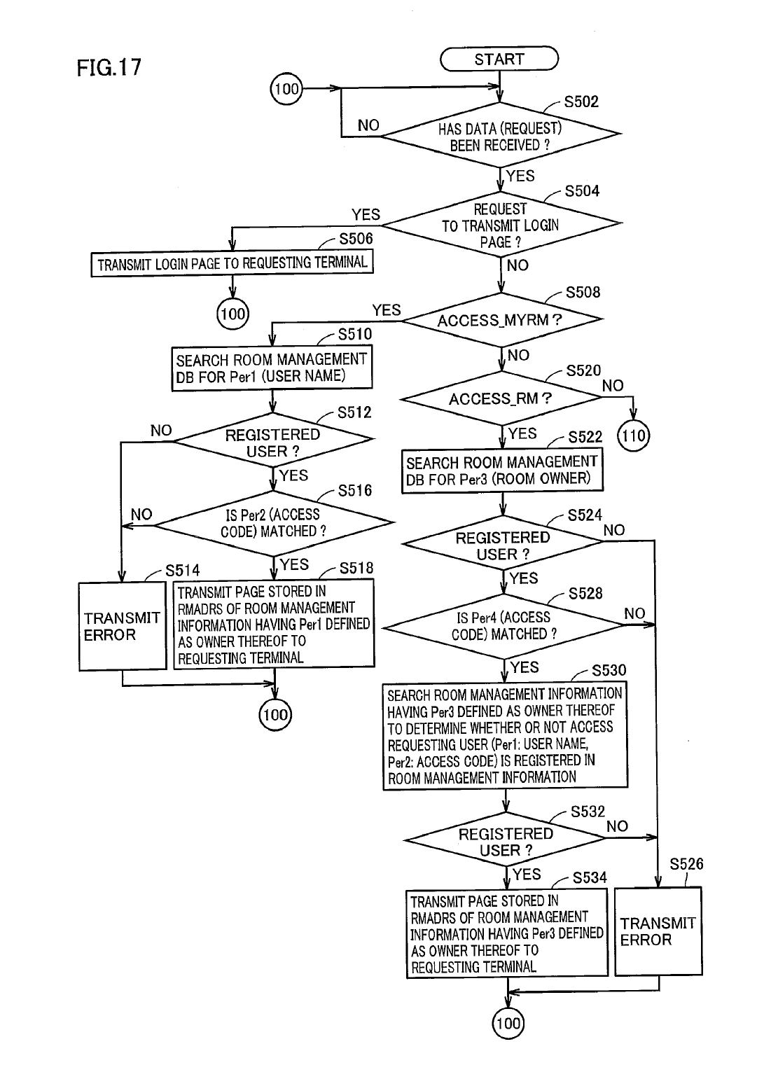

FIG. 16 is an image diagram showing touch panel 105 displaying the room of another user. Referring to FIG. 16, when displaying the room of another user, CPU 110 causes display 103 to show the contents already drawn by another user and the contents already drawn by the user. Together with these contents, CPU 110 causes display 103 to show a leave button 105K for leaving the room of another user, that is, for returning to the state of viewing the user's own room. Then, CPU 110 also causes display 103 to show a status 105L that is related to the room of another user and received from server 200.

Referring back to FIG. 15, CPU 110 determines whether or not the drawing operation has been accepted from the user through touch panel 105 (step S404). If the drawing operation has been accepted from the user (YES in step S404), CPU 110 transmits the input drawing operation to server 200 through communication device 101 (step S406). More specifically, CPU 110 transmits the command name (DRAW), the input user name (Per1), the input access code (Per2), the owner of the room subjected to the drawing operation (Per3), the access code of the room subjected to the drawing operation (Per4), and the information showing the drawing operation (Per5) to server 200 through communication device 101.

CPU 110 causes display 103 to show the drawing contents based on the input drawing operation (step S408). CPU 110 then performs the process from step 5404.

If the drawing operation has not been accepted from the user (NO in step S404),

CPU 110 determines whether or not the “display update” command has been received from server 200 through communication device 101 (step S410). If the “display update” command has been received (YES in step S410), CPU 110 causes display 103 to show the drawing contents based on the received “display update” command (step S412). CPU 110 repeats the process from step 404. It is to be noted that this process is specifically to redisplay (reload) the page (contents) of the room that is transmitted from the server together with the “display update” command and includes the updated contents subjected to the drawing operation performed by another user.

If the “display update” command has not been received (NO in step S410), CPU 110 determines whether or not the leaving operation has been accepted from the user through touch panel 105 (step S414). If the leaving operation has not been accepted from the user (NO in step S414), CPU 110 repeats the process from step S04.

If the leaving operation has been accepted from the user (YES in step S414), CPU 110 issues a request to server 200 through communication device 101 to transmit the user's room page (step S416). More specifically, CPU 110 transmits the command name (ACCESS_MYRM), the input user name (Per1) and the input access code (Per2) to server 200 through communication device 101. CPU 110 then performs the process from step S202.

<Process Procedure in Server 200>

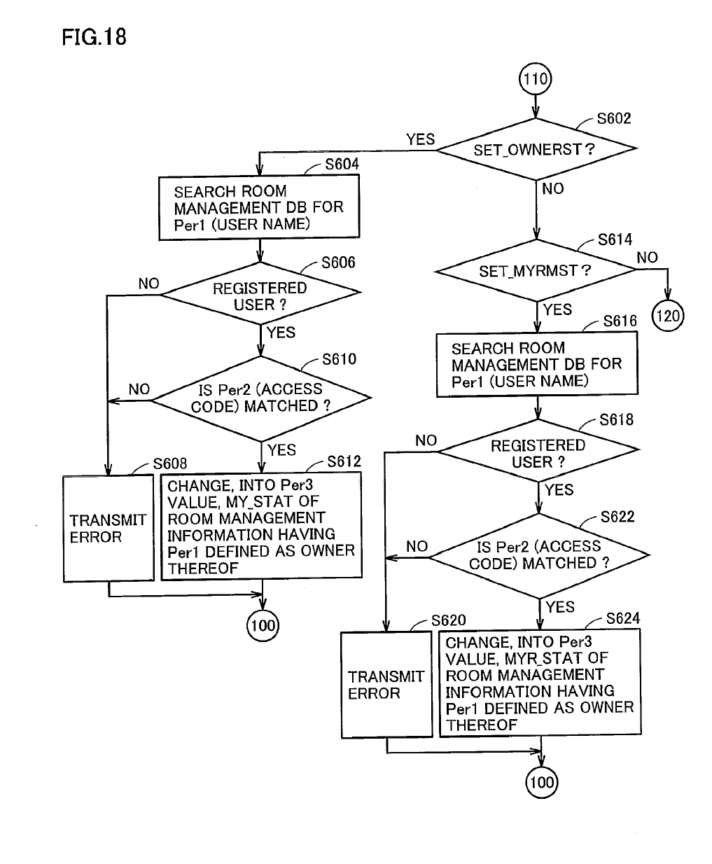

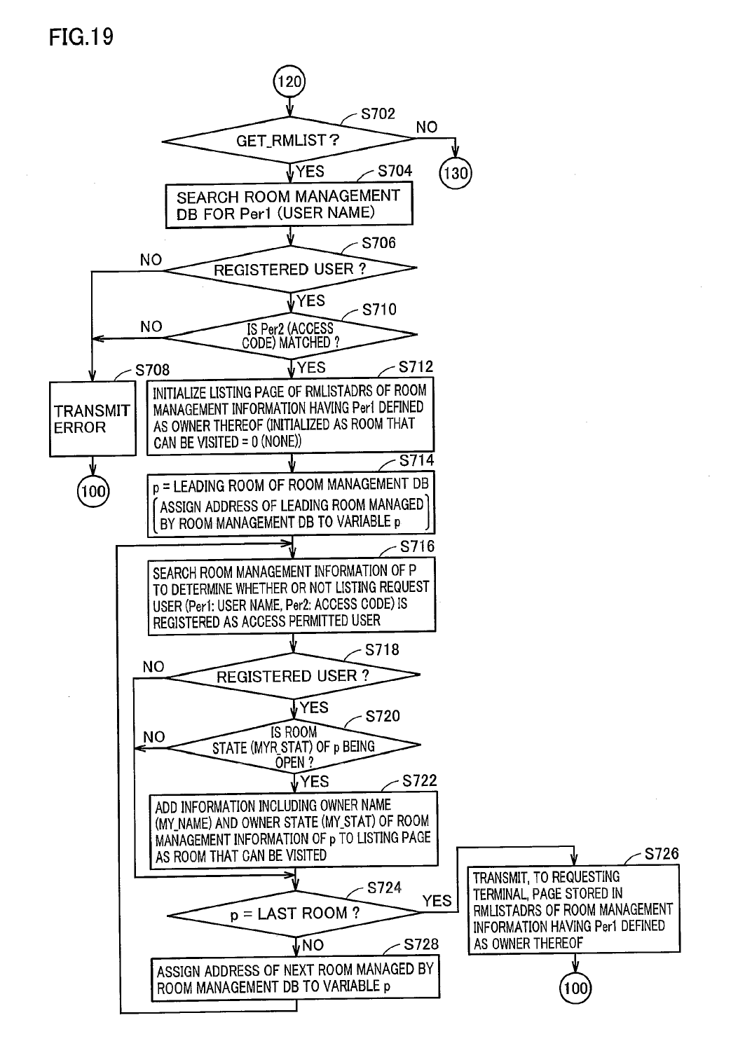

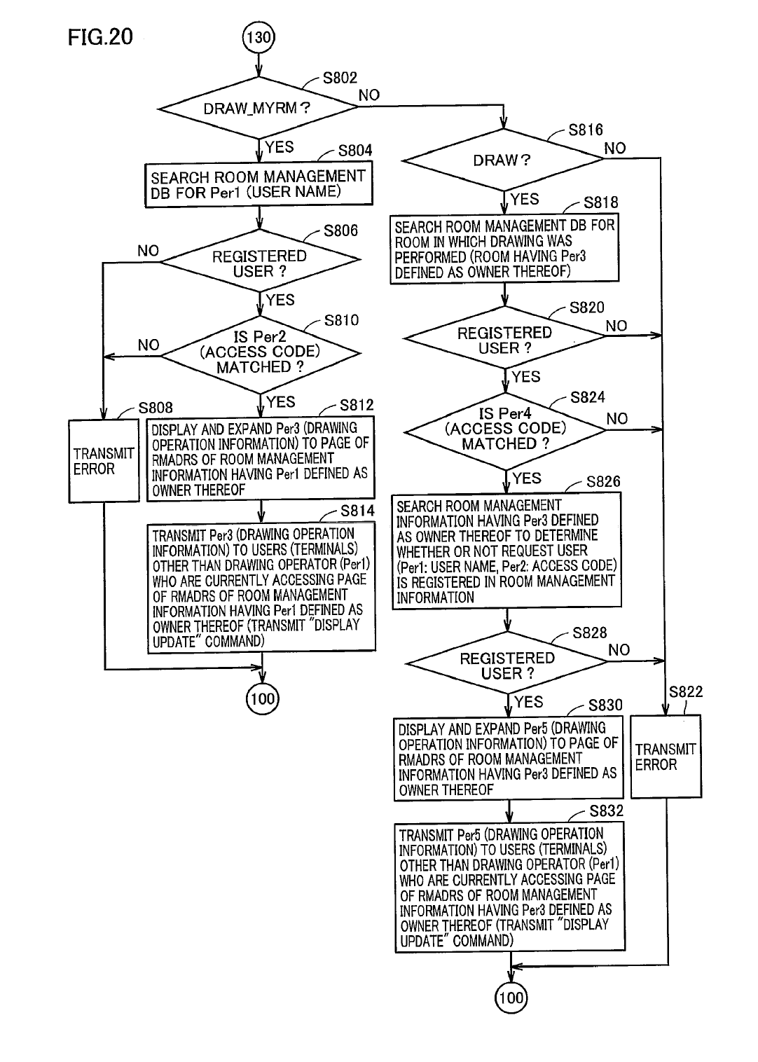

Then, the process procedure in server 200 according to the present embodiment will be hereinafter described. FIG. 17 is the first flowchart illustrating the process procedure in server 200 according to the present embodiment. FIG. 18 is the second flowchart illustrating the process procedure in server 200 according to the present embodiment. FIG. 19 is the third flowchart illustrating the process procedure in server 200 according to the present embodiment. FIG. 20 is the fourth flowchart illustrating the process procedure in server 200 according to the present embodiment.

Referring to FIG. 17, CPU 210 determines whether or not the data has been received from communication terminal 100 through communication device 201 (step S502). If the data has not been received from communication terminal 100 (NO in step S502), CPU 210 repeats the process from step S502.

CPU 210 determines whether or not the received data is a request to transmit a login page (step S504). If the received data is a request to transmit a login page (YES in step S504), CPU 210 refers to memory 202 to read the login page and transmit the login page to communication terminal 100 through communication device 201 (step S506). CPU 210 repeats the process from step S502.

If the received data is not a request to transmit a login page (NO in step S504), CPU 210 determines whether or not the received data includes an ACCESS_MYRM command (step S508). If the received data includes the ACCESS MYRM command (YES in step S508), CPU 210 searches room management database 2021 for the user name (Per1) (step S510). In this way, CPU 210 determines whether or not the user is a registered user (step S512).

If the user is not a registered user (NO in step S512), CPU 210 transmits an error message to communication terminal 100 through communication device 201 (step S514). CPU 210 repeats the process from step S502.

If the user name corresponds to a registered user (YES in step S512), CPU 210 determines whether or not the received access code (Per2) matches the access code corresponding to the user name in room management database 2021 (step S516). If the received access code is not matched (NO in step S516), CPU 210 performs the process from step S514.

If the received access code is matched (YES in step S516), CPU 210 transmits the page (contents) stored in RMADRS of the room having variable Perl defined as an owner thereof to communication terminal 100 through communication device 201 (step S518). CPU 210 repeats the process from step S502.

On the other hand, if the received data does not include the ACCESS MYRM command (NO in step S508), CPU 210 determines whether or not the received data includes ACCESS_RM (step S520). If the received data does not include ACCESS_RM (NO in step S520), CPU 210 performs the process from step 5602.

If the received data includes ACCESS_RM (YES in step S520), CPU 210 searches room management database 2021 for the room owner (Per3) (step S522). CPU 210 determines whether or not the owner of the room is a registered user (step S524). If the owner of the room is not a registered user (NO in step S524), CPU 210 transmits an error message to communication terminal 100 through communication device 201 (S526). CPU 210 then repeats the process from step 5502.

On the other hand, if the room owner is a registered user (YES in step S524), CPU 210 refers to room management database 2021 to determine whether or not the access code is matched (step S528). If the access code is not matched (NO in step S528), CPU 210 performs the process from step S526.

If the access code is matched (YES in step S528), CPU 210 searches the room management information having variable Per3 defined as an owner thereof to determine whether or not the access requesting user (Per1 and Per2) is registered in this room management information (step S530). In this way, CPU 210 determines whether or not the access requesting user is a registered user (step S532). If the access requesting user is not a registered user (NO in step S532), CPU 210 performs the process from step S526.

If the access requesting user is a registered user (YES in step S532), CPU 210 transmits the page stored in RMADRS of the room management information having variable Per3 defined as an owner thereof to communication terminal 100 through communication device 201 (step S534). CPU 210 then transmits the status corresponding to the room (the room having variable Per3 defined as an owner thereof) to communication terminal 100 through communication device 201. CPU 210 repeats the process from step S502.

Referring to FIG. 18, CPU 210 determines whether or not the received data includes a SET_OWNERST command (step S602). If the received data includes SET_OWNERST (YES in step S602), CPU 210 searches room management database 2021 for variable Per1 (user name) (step S604). In this way, CPU 210 determines whether or not the user name is a registered user (step S606). If the user is not a registered user (NO in step S606), CPU 210 transmits an error message to communication terminal 100 through communication device 201 (step S608). CPU 210 repeats the process from step S502.

If the user is a registered user (YES in step S606), CPU 210 determines whether or not Per2 (access code) is matched (step S610). If Per2 (access code) is not matched (NO in step S610), CPU 210 repeats the process from step S608.

If Per2 (access code) is matched (YES in step S610), CPU 210 changes, into Per3, MY_STAT of the room management information having Perl defined as an owner thereof (step S612). CPU 210 repeats the process from step S502.

If the received data does not include the SET OWNERST command (NO in step S602), CPU 210 determines whether or not the received data includes a SET_MYRMST command (step S614). If the received data does not include the SET_MYRMST command (NO in step S614), CPU 210 performs the process from step S702.

If the received data includes the SET_MYRMST command (YES in step S614), CPU 210 searches room management database 2021 for variable Per1 (user name) (step S616). In this way, CPU 210 determines whether or not the user name belongs to a registered user (step S618). If the user name does not belong to a registered user (NO in step S618), CPU 210 transmits an error message to the communication terminal through communication device 201 (step S620). CPU 210 repeats the process from step S502.

If the user name belongs to a registered user (YES in step S618), CPU 210 determines whether or not a variable Per2 (access code) is matched (step S622). If variable Per2 (access code) is not matched (NO in step S622), CPU 210 performs the process from step S620.

If variable Per2 (access code) is matched (YES in step S622), CPU 210 changes, into variable Per3, MYR STAT of the room management information having variable Per1 defined as an owner thereof (step S624). CPU 210 repeats the process from step S502.

Referring to FIG. 19, CPU 210 determines whether or not the received data includes a GET_RMLIST command (step S702). If the received data does not include the GET_RMLIST command (NO in step S702), CPU 210 performs the process from step S802.

If the received data includes the GET_RMLIST command (YES in step S702), CPU 210 searches room management database 2021 for variable Per1 (user name) (step S704). CPU 210 then determines whether or not the user name belongs to a registered user (step S706). If the user name does not belong to a registered user (NO in step S706), CPU 210 transmits an error message to communication terminal 100 through communication device 201 (step S708). CPU 210 repeats the process from step S502.

If the user name belongs to a registered user (YES in step S706), CPU 210 determines whether or not variable Per2 (access code) is matched (step S710). If variable Per2 (access code) is not matched (NO in step S710), CPU 210 performs the process from step S708.

If variable Per2 (access code) is matched (YES in step S710), CPU 210 initializes the listing page of RMLISTADRS of the room management information having variable Perl defined as an owner thereof (step S712). CPU 210 substitutes 0 (none) into the room that can be visited.

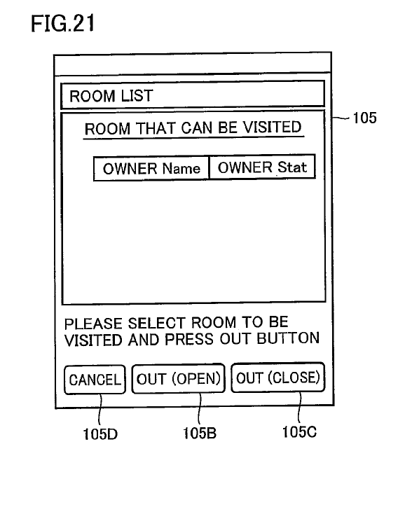

FIG. 21 is an image diagram showing list 105A at initialization. Referring to FIG. 21, the figure shows list 105A in which the room that the user of communication terminal 100 is authorized to access is associated with the state of the terminal of the user corresponding to this room.

Referring back to FIG. 19, CPU 210 assigns the address of the leading room managed by room management database 2021 to a variable p (step S714). CPU 210 searches the room management information corresponding to variable p to determine whether or not the listing request user (Per1 and variable Per2) is registered in the room management information as an access permitted user (step S716).

CPU 210 determines whether or not the listing request user is a registered user (step S718). If the listing request user is not a registered user (NO in step S718), CPU 210 performs the process from step S724.

If the listing request user is a registered user (YES in step S718), CPU 210 determines whether or not the room state (MYR STAT) corresponding to variable p is being opened (step S720). If the room state of variable p is not being opened (NO in step S720), CPU 210 performs the process from step S724.

If the room state of variable p is being opened (YES in step S720), CPU 210 adds, to the listing page, the information including an owner name (MY NAME) and an owner state (MY STAT) of the room management information corresponding to variable p as a room that can be visited (step S722). CPU 210 then determines whether or not variable p is the last room number (step S724).

If variable p is the last room number (YES in step S724), CPU 210 transmits the page stored in RMLISTADRS of the room management information having variable Perl defined as an owner thereof to communication terminal 100 through communication device 201 (step S726). CPU 210 repeats the process from step 5502.

If variable p is not the last room number (NO in step S724), CPU 210 assigns the address of the next room managed by room management database 2021 to variable p (step S728). CPU 210 repeats the process from step S716.

Referring to FIG. 20, CPU 210 determines whether or not the received data includes a DRAW_MYRM command (step S802). If the received data includes the DRAW MYRM command (YES in step S802), CPU 210 searches room management database 2021 for variable Per1 (user name) (step S804). In this way, CPU 210 determines whether or not the user name belongs to a registered user (step S806).

If the user name does not belong to a registered user (NO in step S806), CPU 210 transmits an error message to communication terminal 100 through communication device 201 (step S808). CPU 210 repeats the process from step S502.

If the user name belongs to a registered user (YES in step S806), CPU 210 determines whether or not variable Per2 (access code) is matched (step S 810). If variable Per2 (access code) is not matched (NO in step S810), CPU 210 performs the process from step S808.

If variable Per2 (access code) is matched (YES in step S810), CPU 210 expands Per3 (drawing operation information) to the page of RMADRS of the room management information having variable Perl defined as an owner thereof (S812). CPU 210 then transmits variable Per3 (drawing operation information) through communication device 201 to the users (communication terminals 100) other than the drawing operator (Per1) who are currently accessing the page of RMADRS of the room management information having variable Per1 defined as an owner thereof (step S814). In other words, CPU 210 transmits the “display update” command to communication terminal 100 through communication device 201. CPU 210 repeats the process from step S502.

If the received data does not include the DRAW_MYRM command (NO in step S802), CPU 210 determines whether or not the received data includes a DRAW command (step S816). If the received data does not include the DRAW command (NO in step S816), CPU 210 transmits an error message to communication terminal 100 through communication device 201 (step S822). CPU 210 repeats the process from step S502.

If the received data includes the DRAW command (YES in step S816), CPU 210 searches room management database 2021 for the room in which drawing was performed (the room having variable Per3 defined as an owner thereof) (step S818). In this way, CPU 210 determines whether or not the user stored in variable Per3 is a registered user (step S820). If the user stored in variable Per3 is not a registered user (NO in step S820), CPU 210 performs the process from step S822.

If the user corresponding to variable Per3 is a registered user (YES in step S820), CPU 210 determines whether or not variable Per4 (access code) is matched (step S824). If variable Per4 (access code) is not matched (NO in step S824), CPU 210 performs the process from step S822.

If variable Per4 (access code) is matched (YES in step S824), CPU 210 searches the room management information having variable Per3 defined as an owner thereof to determine whether or not the request user (combination of Per1 and Per2) is registered in this room management information (step S826). In this way, CPU 210 determines whether or not the request user is a registered user (step S828). If the request user is not a registered user (NO in step S828), CPU 210 performs the process from step S822.

If the request user is a registered user (YES in step S828), CPU 210 expands variable Per5 (drawing operation information) to the page of RMADRS of the room management information having variable Per3 defined as an owner thereof (step S830). CPU 210 then transmits variable Per5 (drawing operation information) through communication device 201 to the users (communication terminals 100) other than the drawing operator (Per1) who are currently accessing the page of RMADRS of the room management information having variable Per3 defined as an owner thereof (step S832).

In other words, CPU 210 transmits a “display update” command to the communication terminal through communication device 201. CPU 210 repeats the process from step S502.

<With regard to Page (Contents) Transmitted from Server>

In general, the page (contents) transmitted from the server is not simply display data but a program code (a machine language code executable by CPU 110 that shows a control instruction and a control procedure to an input/output device, and a script expandable by a browser (viewing) software to a machine language code that is executable by CPU 110). Specifically, in the flowchart (FIG. 9) showing the process procedure of the process for entering the user's own room, only display (execution) of the page transmitted from the server in step S202 is performed by browser (viewing) software control (control performed by the program code statically stored (in advance) in memory 102 of communication terminal 100). Subsequent steps S204 to S228 are the process performed by execution of the page. In other words, the actual entity of the process for entering the room (program code) is not statically stored (in advance) in memory 102 of communication terminal 100 but is a dynamic program code executed by the process of downloading the page (contents) (the process for receiving, storing and executing the page (contents) distributed by the transmission request to the server).

### Other Embodiments

It is needless to say that the present invention can be applied also when being implemented by providing a program in a system or a device. The effect of the present invention can be enjoyed by providing, in a system or a device, a storage medium storing the program represented by the software for implementing the present invention, and causing the computer (or a CPU and an MPU) of the system or the device to read and execute the program code stored in the storage medium.

In this case, the program code itself read from the storage medium is to implement the function of the embodiment mentioned above, and the storage medium storing this program code is to configure the present invention. The storage medium for providing a program code may be, for example, a hard disk, an optical disk, a magneto-optical disc, a CD-ROM, a CD-R, a magnetic tape, a nonvolatile memory card (IC memory card), a ROM (a mask ROM, a flash EEPROM, and the like), and the like.

Furthermore, it is needless to say that, by executing the program code read by the computer, not only the functions of the embodiment described above are implemented, but also the OS (operating system) and the like operating on the computer may perform some or all of the actual processes based on the instruction of the program code, thereby implementing the functions of the embodiment described above.

Furthermore, it is also needless to say that, after the program code read from the storage medium is written in the memory provided in a function expansion board inserted into the computer or a function expansion unit connected to the computer, based on the instruction of this program code, the CPU and the like provided in the function expansion board or the function expansion unit may perform some or all of the actual processes, thereby implementing the functions of the embodiment described above.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1 network system, 99 stylus pen, 100, 100A, 100B, 100K communication terminal, 101 communication device, 102 memory, 103 display, 104 tablet, 105 touch panel, 105A list, 105B out button, 105C out button, 105D cancel button, 105E login button, 105F switching button, 105G out button, 105H leave button, 1051 drawing button, 105J deletion button, 105K leave button, 106 button, 200 server, 201 communication device, 202 memory, 300 network, 2021 room management database, 2022 room page, 2023 room listing, 2024 login page, A, B, C, D, E, F, G, H, I, J, K room.

1. A network system comprising a plurality of terminals and a server,
said server including:
a server communication device for communicating with said plurality of terminals;
a memory for storing, for each room corresponding to a user of each of said plurality of terminals, contents and a status showing a state of said terminal; and
a server processor having first server control storing said status transmitted from said terminal in said memory, said status being associated with the room corresponding to the user of said terminal, and second server control referring to said memory in accordance with designation of said room transmitted from said terminal, to transmit said contents and said status associated with said designated room to said terminal,
each of said plurality of terminals including:
a display;
an input device;
a terminal communication device for communicating with said server; and
a terminal processor having first terminal control transmitting the state of a user's own terminal as said status to said server, and second terminal control transmitting the designation of said room input through said input device to said server, to cause said display to show said contents and said status corresponding to said designated room transmitted from said server.

2. The network system according to claim 1, wherein the status showing the state of said terminal shows whether or not said terminal displays said contents of said room corresponding to the user of said terminal.

3. The network system according to claim 1, wherein
said server processor refers to said memory based on a first request from said terminal to transmit a list showing said status corresponding to each of a plurality of the rooms through said server communication device, and
said terminal processor causes said display to show said list received from said server, and accepts an instruction for selecting said room as designation of said room from said list through said input device.

4. The network system according to claim 1, wherein, in response to a second request from said terminal, said server processor inhibits another said terminal of the plurality of terminals from accessing said room corresponding to said terminal.

5. A communication method in a network system including a plurality of terminals and a server,
said server including a memory storing, for each room corresponding to a user of each of said plurality of terminals, contents and a status showing a state of said terminal,
said communication method comprising the steps of:
a first terminal of said plurality of terminals transmitting a status of said first terminal to said server;
said server storing the status of said first terminal in said memory;
a second terminal of said plurality of terminals transmitting designation of said room corresponding to the user of said first terminal to said server;
said server transmitting said contents and said status corresponding to said designated room to said second terminal; and
said second terminal causing a display to show said contents and said status.

6. A communication terminal for communicating with a server storing contents and a status for each room, said communication terminal comprising:
a display;
an input device;
a terminal communication device for communicating with the server; and
a terminal processor having first terminal control transmitting a state of a user's own terminal as said status to said server, and second terminal control transmitting designation of said room input through said input device to said server, to cause said display to show said contents and said status corresponding to said designated room transmitted from said server.

7. A communications server comprising:
a server communication device for communicating with a plurality of terminals;
a memory storing, for each room corresponding to a user of each of said plurality of terminals, contents and a status showing a state of said terminal; and
a server processor having first server control storing said status transmitted from said terminal in said memory, said status being associated with the room corresponding to the user of said terminal, and second server control referring to said memory in accordance with designation of said room transmitted from said terminal, to transmit said contents and said status associated with said designated room to said terminal.
